(19) United States
(12) Patent Application Publication
(10) Pub. No.: US 2020/0347821 A1
(43) Pub. Date: Nov. 5, 2020

(54) METHOD FOR EVALUATING AN INFLOW ON A ROTOR BLADE OF A WIND TURBINE, METHOD FOR CONTROLLING A WIND TURBINE, AND A WIND TURBINE

(71) Applicant: Wobben Properties GmbH, Aurich (DE)

(72) Inventor: Christian Frank NAPIERALA, Aurich (DE)

(21) Appl. No.: 16/069,127

(22) PCT Filed: Jan. 13, 2017
(86) PCT No.: PCT/EP2017/050687

§ 371 Date: Jul. 10, 2018

(30) Foreign Application Priority Data
Jan. 13, 2016 (DE) 10 2016 100 522.3

(51) Int. Cl. F03D 7/02; F03D 17/00

(52) U.S. Cl. CPC F03D 7/0224; F03D 17/00; F03D 7/0296; F03D 7/028; F03D 7/0276

(57) ABSTRACT

A method for determining an incident flow at a rotor blade of a wind power installation is provided. The method includes recording at least part of a pressure spectrum of pressure, in particular wall pressure, at the rotor blade at at least one measurement position. The method includes determining at least two characteristic values from the pressure spectrum, determining an indicator value from a relationship between the at least two characteristic values and assessing whether a critical incident flow is present depending on the indicator value.

### BACKGROUND

### Technical Field

The present invention relates to a method for evaluating an incident flow at a rotor blade of a wind power installation. Moreover, the present invention relates to a method for operating a wind power installation. The invention also relates to a wind power installation.

### Description of the Related Art

Wind power installations are known and frequently set up. A so-called OAM (“other amplitude modulation”) noise arises at some sites. The noise substantially arises at sites that have particularly large gradients in the wind speed over the rotor disk. Such OAM noise can also arise under certain atmospheric conditions, which likewise cause large gradients. The assumption is made that very large angles of attack occur on the rotor blade when the blade passes through the so-called 12 o'clock position, i.e., stands perpendicularly upward, as result of substantially higher wind speeds at higher altitudes. Then, a critical incident flow arises. In particular, there is the risk here of a stall, as discussed, for example, in S. Oerlemans, “Effect of wind shear on amplitude modulation of wind turbine nose,” DOI: 10.1260/1475-472X.14.5-6.715. In this respect, a critical incident flow is one in which there is a risk of a stall.

If the angle of attack exceeds a certain critical value, there is a spontaneous separation of the boundary layer, which also has great effects on the volume and characteristic of the aeroacoustic noise of a wind power installation. A short time later, when the rotor blade has passed through the 12 o'clock position, the angle of attack reduces again, the flow adjoins the profile again and the intensity and the characteristic of the noise is lower or “normal” again.

Since the following blade is incident on a similar atmosphere, i.e., similar boundary conditions, the same phenomenon arises again. This is perceived as a modulation of the intensity of the low-frequency noise with the blade passage frequency. In contrast to the directional characteristic of a “normal” trailing edge noise, i.e., of a trailing edge noise that occurs continuously, the separation noise tends to emit more dipole-like in the direction of the rotor axis and can thus—also due to the increased intensity in the low-frequency band that is hardly dampened by the atmosphere—bridge very large distances such as more than 2 kilometers (km), for example, and it is then audible at locations at which the installation normally cannot be perceived.

One option of reducing this modulation of the intensity of the low-frequency noise consists, in principle, of a general reduction in the noise level and of an operation of the wind power installation in throttled operation, for example, in which, in particular, the power, too, is throttled. On the other hand, it is undesirable as a matter of principle to throttle the power or rotational speed and this should therefore be carried out as little as possible.

Methods of detecting an OAM event in a far field in order to intervene in the closed-loop control are also known. However, such a detection in the far field is complicated and can only detect the noise once it has already occurred.

Other methods are based on determining the angle of attack, even though the critical angle of attack depends on the properties of the boundary layer around the rotor blade profile and hence on the condition of the surface, in particular on dirt collected on the surface, too. Moreover, a particularly high accuracy in the determination of the angle of attack is important here such that the method can react particularly susceptibly to inaccuracies.

In the priority application of the present application, the German Patent and Trade Mark Office has searched the following prior art: DE 10 2014 210 949 A1, DE 20 2013 007 142 U1, US 2002/0134891 A1 and the articles “Effect of Airfoil Aerodynamic Loading on Trailing-Edge Noise Sources” by Stephane Moreau et al. and “Flow Features and Self-Noise of Airfoils Near Stall or in Stall” by Stephane Moreau et al.

### BRIEF SUMMARY

Modulation of the intensity of the low-frequency noise, which is perceived with the blade passage frequency, can be reduced to the best possible extent and/or as early as possible.

In a method, an incident flow at a rotor blade is assessed and hence it is possible, in particular, to then identify a critical incident flow, in particular a threatening stall or a tendency to separate. To this end, the method proposes assessing an incident flow at at least one rotor blade of a wind power installation and, to this end, carry out at least the following steps:
recording at least part of a pressure spectrum of a pressure, in particular wall pressure at the rotor blade at at least one measurement position,
determining at least two characteristic values from the pressure spectrum,
forming an indicator value from a relationship between the at least two characteristic values and
assessing whether a critical incident flow is present, depending on the indicator value.

Consequently, at least part of a pressure spectrum of a wall pressure at the rotor blade is initially recorded at at least one measurement position. To this end, a pressure sensor, in particular a pressure sensor operating on a potential-free basis, can be arranged in the region of a rotor blade surface in such a way that it measures, in particular continuously, optionally within the scope of digital sampling, the pressure there, the pressure occurring there in the region of the rotor blade or being applied to the rotor blade at the measurement position. This pressure can also be referred to as a wall pressure. Here, the pressure is qualitatively recorded in such a way that a spectrum is identifiable and evaluable. In this respect, a dedicated pressure signal is recorded which ostensibly approximately corresponds to the measuring of a noise by a microphone. Ultimately, a microphone is also a pressure sensor and a microphone can also be used as a pressure sensor.

At least two characteristic values are determined from the pressure spectrum recorded thus; it being possible, for example, to evaluate said pressure spectrum at regular intervals by means of a Fast Fourier Transform (FFT). Particularly preferably, at least two characteristic values of different frequencies or frequency bands are determined, i.e., two characteristic values from two different frequency ranges of the recorded pressure spectrum.

An indicator value is formed using these at least two characteristic values from a relationship of said values with respect to one another. In one case, this relationship can be a ratio or quotient of the two characteristic values with respect to one another. Then, it is sufficient to evaluate two values. However, it is also possible to evaluate more than two values by virtue of these being grouped in a frequency-dependent manner, for example, in particular being grouped into two groups and these groups then being related to one another or by virtue of determining a characteristic value for these groups in each case and then relating these to one another.

In order to name but a further example, it would also be possible, for example in the case of more than two values, to multiply form a relationship between two of the values in each case in order to form the indicator value therefrom.

Then, depending on this indicator value, an assessment is made as to whether a critical incident flow is present. In particular, a critical incident flow, i.e., a critical incident flow at the rotor blade, is one that tends to separate. It was recognized that such a separation tendency could be recognized on the basis of the captured noise. In the process, it was also recognized that the frequency response, i.e., the pressure spectrum, could provide information about such a critical incident flow. Accordingly, the pressure spectrum can naturally also provide information about when an incident flow is non-critical.

By virtue of the two characteristic values being related to one another in order to form the indicator value, an accuracy of the measurement, in particular in respect of the absolute amplitudes thereof, can play a subordinate role. Consequently, a calibration, in particular, can play a subordinate role or even be dispensable for the measurement recording as such, provided the frequency response in the considered frequency range is constant or otherwise known.

Preferably, the at least two characteristic values have a first and second spectral value, where the first and second spectral values characterize a low and a high frequency range, respectively. In particular, the recorded or evaluated pressure spectrum is subdivided into two frequency ranges, namely the low frequency range and the high frequency range. Both frequency ranges are characterized by a spectral value in each case. A characterization option could also lie in using a recorded value from each of the two frequency ranges, for example, from the center of the respective frequency range in each case there. If these two spectral values are now related, for example by forming a quotient or difference, this also allows conclusions to be drawn about the relationship and, in particular, the ratio of the two frequency ranges with respect to one another.

Evaluating whether a critical incident flow is present is therefore carried out depending on the indicator value and hence depending on the relationship of the two frequency ranges with respect to one another. In particular, a critical incident flow is present if the pressure spectrum in the low frequency range is higher than in the high frequency range. Thus, in particular, a critical incident flow can be present if the first spectral value is greater than the second spectral value.

Preferably, the pressure spectrum is embodied as a power density spectrum or examined as a power density spectrum and, in the process, subdivided into a first and a second partial power density spectrum, where the first partial power density spectrum lies in the low frequency range and the second partial power density spectrum lies in the high frequency range. In this respect, the suggestion is for the at least two characteristic values to be embodied as first and second spectral components and in each case be formed by integration of the first and second partial power density spectrum over the low and high frequency ranges, respectively. Consequently, it is possible in each case to form a characteristic value for each of the two partial power density spectra and hence for each of the two frequency ranges. As a result, the entire considered partial power density spectrum flows into the respectively formed characteristic value in each case. Consequently, it is possible to capture the entire partial power density spectrum in each case and take it into account when forming the indicator value from the relationship of the two spectral components. The above-described first and second spectral values can be embodied as first and second spectral components, respectively.

One embodiment proposes that the low frequency range lies between a lower and mid frequency and the high frequency range lies between the mid and an upper frequency. These lower, mid and upper frequencies are prescribable in each case. The two frequency ranges can be defined by prescribing these frequency values. As a result, it is possible to choose the frequency ranges in such a way that the characteristic values, in particular the first and second spectral value or the first and second spectral component, emerge in such a way that their relationship with respect to one another is meaningful for the evaluation of the incident flow.

Preferably, the mid frequency is set in such a way that the power density spectrum has a maximum in the low frequency range when a critical incident flow is present. By way of example, it is possible to carry out trials in the wind tunnel, or else by way of simulations, which modify the incident flow at the rotor blade particularly naturally in the region of the measurement position such that said incident flow transitions into a critical incident flow. Here, power density spectra can be recorded and evaluated. In the present case, a change in the maximum of the power density spectrum will also be recorded and it is then possible to set the mid frequency in such a way that the power density spectrum has a maximum in the low frequency range, i.e., lies below the said mid frequency, when a critical incident flow is present. In particular, this mid frequency naturally is selected in such a way that the maximum lies above the mid frequency in the case of a non-critical incident flow.

Moreover, or alternatively, setting the lower, mid and upper frequency in such a way that the low frequency range and the high frequency range have the same size is proposed, i.e., for example, both frequency ranges cover 200 Hz in each case to name but one example. The choice of equally sized frequency ranges is one embodiment, particularly for the integration of the partial power spectra, in order thereby to seek for a good comparability of the results of these integrations of the partial power density spectra. A uniform arithmetic division underlies this example. According to one embodiment, a logarithmic subdivision can underlie the subdivision such that both frequency ranges have the same size.

Moreover, or alternatively, setting the lower, mid and upper frequency depending on a degree of dirtying or a degree of erosion of the rotor blade is proposed. This also means that a change of the frequency ranges can be undertaken after a certain operational duration of half a year, one year or several years, for example, in order to counteract changes as a result of erosion. In principle, this is based on the discovery that the characteristic of the power density spectrum can change with an increasing degree of dirtying of the rotor blade. In order to take this into account, it is possible to undertake specific or general examinations in the wind tunnel or in a simulation in order to capture such changes in the power density spectrum. In particular, it was recognized that the maximum of the power density spectrum can also shift and that it may be correspondingly advantageous for an evaluation that is as good as possible to then appropriately displace or re-select at least the mid frequency. Preferably, the lower and upper frequency are modified accordingly for adaptation purposes, too.

According to a preferred embodiment, the lower, mid and upper frequency can be selected in such a way that the evaluation is tolerant or robust in relation to a change of the rotor blade from a clean to a dirtied state.

A further embodiment proposes that the lower, mid and upper frequency are set depending on sound emission limits at the installation site of the wind power installation. Sound emission values of the wind power installation can be derived from the relationship of the characteristic values, in particular from the relationship of the first spectral value to the second spectral value or the first spectral component to the second spectral component. This, too, can be examined in a wind tunnel or at a test installation. Once such relationships have been captured, it is possible to set the lower, mid and/or upper frequencies in order to observe sound emission limits that are required in each case.

A further embodiment proposes that the lower, mid and upper frequency are set depending on sound measurements in the region of the wind power installation. This renders it possible to set these values in a simple manner, in particular for the purposes of a test operation at the respective installation. As a result, it is de facto possible to take account of specific ambient conditions of the respective wind power installation or of the relevant installation site.

One embodiment proposes that the lower, mid and upper frequency are set to values in the region of 200 Hz, 400 Hz and 600 Hz, respectively, or to values in the corresponding regions. The values of 200 Hz, 400 Hz and 600 Hz were found to be good values, even for different installations. However, the specified three exact values are not necessarily important and hence it is also possible to provide a setting in the region around the aforementioned three values, for example within an interval of ±20 Hz about the respective value in each case or by ±50 Hz about the respective value.

An advantageous configuration proposes that the indicator value is a quotient of two of the at least two characteristic values or of the first and second spectral value or of the first and second spectral component. The proposed evaluation is then carried out in such a way that a critical incident flow is assumed, i.e., a critical incident flow is assessed as being present, if the indicator value lies above a specifiable ratio limit value. Preferably, such a ratio limit value is greater than 1.

As a result of forming this quotient, the absolute values, from which the quotient is formed, are no longer important or less important. Consequently, only a ratio is formed and, consequently, only one characteristic is evaluated as a result, but no absolute values are evaluated, even though absolute values are naturally included in the calculation. In any case, this allows the characteristic to be evaluated in a simple manner. This is based on the discovery that, in particular, a situation in which there is a separation tendency of the airflow can be derived from an evaluation of the characteristic.

Alternatively, one of the characteristic values could also be compared to an absolute comparison value. By way of example, the comparison of the quotient of the first and second characteristic value to the ratio limit value corresponds to a comparison of the first characteristic value to the product of the second characteristic value and the ratio limit value, and consequently this would be an equivalent implementation.

In any case, this comparison of the quotient to the ratio limit value allows an evaluation as to whether a critical incident flow is present to be undertaken in a simple manner. Particularly preferably, a critical incident flow can be assumed in the case of a quotient >1 and a non-critical or normal incident flow can be assumed in the case of a quotient <=1. Nevertheless, specifying a specific ratio limit value that, in particular, can be greater than 1 is a preferred embodiment. As a result of this, it is possible to provide a clear and unique definition from when a critical incident flow can be assumed.

Such ratio limit values can also be specified depending on the specific wind power installation or depending on specific boundary conditions. In particular, a degree of dirtying of the relevant rotor blade can be included here. As a result, it is possible to take account of the fact that a different separation tendency may also be present in the case of different degrees of dirtying. The underlying technical conditions can sometimes be quite complicated. However, they can be implemented easily and uniquely here for the evaluation to be carried out by setting a corresponding ratio limit value. If the frequency ranges, picking up this example, can be set dependent on the degree of dirtying of the rotor blade, too, this can be matched accordingly to the prescription of the ratio limit value.

A further embodiment proposes that the at least one measurement position is arranged in the region of a rotor blade trailing edge of the rotor blade. In particular, a separation of the flow occurs in the region of the rotor blade trading edge first, and so it is also possible to better detect a separation tendency and hence a critical incident flow at said point. Moreover, the sensors are protected comparatively well from erosion processes at this site.

Moreover, or alternatively, arranging the measurement position at the suction side of the rotor blade is proposed. This also takes account of the fact that a separation tendency is to be expected on the suction side, at least in the phenomenon underlying this case, in particular. This is because a higher wind speed is to be expected precisely in the case of rotor blades in a so-called 12 o'clock position in the specified phenomenon than when the rotor blade is in a 6 o'clock position, in order to mention these two extreme positions for illustration purposes. As a result of an increased wind speed, there is also a change in the angle of attack, namely of the type allowing a separation tendency to occur on the suction side of the rotor blade. However, separation can possibly also occur in the 6 o'clock position, namely at the pressure side of the rotor blade, in particular.

Here, the angle of attack is the angle at which the apparent wind flows at the relevant rotor blade profile. By adjusting the blade angle, in particular by an appropriate actuation of at least one pitch motor, there is also a change in the angle of attack as a result. To the extent that reference is made to an adjustment of the angle of attack both here and below, this should be understood to mean an adjustment of the blade angle which de facto leads to an adjustment of the angle of attack.

A further embodiment proposes that the measurement position is arranged in an outer region of the rotor blade in relation to the longitudinal axis thereof, in particular in a range of 60% to 95%, in particular 75% to 85%, from a connection region of the rotor blade, i.e., from the rotor blade root, to a blade tip of the rotor blade. The described phenomenon should be particularly expected in this region because there is a high trajectory speed of the rotor blade here, and also still a significant profile, i.e., in particular, a large cord length. Expressed differently, providing the measurement position on the outside, but not completely outside at the blade tip, is proposed.

Preferably, a plurality of measurement positions are provided, in particular one at each rotor blade or, particularly preferably, a plurality at each rotor blade. It may be advantageous, particularly in the case of a measurement at each rotor blade, to provide an evaluation centrally in the rotor hub.

Preferably, the indicator value is subjected to low pass filtering, i.e., filtering by a filter function with a low-pass characteristic. From measurement data of wind tunnel trials, it was recognized that the indicator value might be subject to very large variations, in particular that it may be noisy. Therefore, low-pass filtering of the indicator is proposed. A measurement and evaluation that is based on wind tunnel measurement data and employs the use of single-stage exponential smoothing was also examined. It was found that this could also suppress the noise and some outliers with good success; however, the indicator becomes sluggish as a result thereof, namely exhibiting a dynamic step response.

Moreover, a method for controlling a wind power installation is proposed according to the invention, said method underlying a wind power installation having a rotor with at least one rotor blade that is adjustable in terms of its blade angle. In particular, a rotor with three such rotor blades will be provided. This method comprises the steps of:
evaluating a pressure measurement at at least one rotor blade at at least one measurement position,
assessing whether a critical incident flow is present at the rotor blade depending on the evaluation of the pressure measurement and
adjusting the rotor blade in terms of its angle of attack if an incident flow was assessed as critical in order to improve the incident flow.

Thus, at least one pressure measurement is undertaken at at least one rotor blade and evaluated. In particular, the evaluation may contain a frequency analysis or an evaluation using band passes with subsequent signal analysis. Then, depending on the evaluation of the pressure measurement, there is an assessment as to whether a critical incident flow is present at the rotor blade and a reaction is thereupon carried out where necessary, i.e., if an incident flow was evaluated as critical, by virtue of the relevant rotor blade being reduced in terms of its angle of attack. Here, the rotor blade is adjusted in such a way that the incident flow is improved. Thus, the adjustment is carried out in such a way that a separation tendency is reduced or removed. In particular, the rotor blade is rotated further into the wind to this end; i.e., the blade angle is increased.

A method according to at least one of the embodiments described above is used, in particular for assessing whether a critical incident flow is present. Thus, in particular, use is made of the method of recording at least part of a pressure spectrum at the rotor blade at a measurement position and determining two characteristic values from the pressure spectrum and determining an indicator value therefrom, namely from the relationship of these two characteristic values with respect to one another. Finally, an assessment as to whether a critical incident flow is present is implemented using this, depending on the formed indicator value.

Then, the rotor blade is adjusted in such a way that the indicator value is reduced to below a limit value, in particular below the ratio limit value, again. Accordingly, continuously repeating such an assessment method, for example 10 times per second, optionally with a measurement window that overlaps in time, and accordingly also carrying out the assessment step anew again and again is proposed. If an indicator value lying above the ratio limit value is determined, the corresponding rotor blade is consequently adjusted in terms of its angle of attack and the indicator value will accordingly decrease again, too. This can be observed and the adjustment of the blade angle can accordingly orient itself thereon.

An adjustment carried out in this manner is preferably carried out for all rotor blades of the wind power installation and can be maintained, in particular over at least one revolution, in particular over a plurality of revolutions of the rotor.

Preferably, an upper and a lower hysteresis limit value is provided, where an adjustment is started when the indicator value exceeds the upper hysteresis limit value, but the adjustment is continued until the indicator value drops below the lower hysteresis limit value. Here, the lower hysteresis limit value is smaller than the upper hysteresis limit value, and so this spans a hysteresis range. This can prevent continuous closed-loop control about a single limit value already as a result of changing measurements.

It was recognized that often conditions for OAM are only present for a short time, in particular for a period of time of less than a minute. In order to take this into account, an embodiment proposes the provision of a timer, i.e., a predetermined time duration, which allows the wind power installation to return to normal operation in the case where the lower hysteresis limit value is permanently undershot within a predetermined time interval, in particular one minute. Consequently, the adjustment of the rotor blade is undone again after the timer has expired, i.e., after the predetermined time duration after the last time the lower hysteresis value has been continuously undershot has expired.

In particular, a method for controlling a wind power installation is proposed, said method including the following steps:
recording at least part of a pressure spectrum of a pressure at a rotor blade, in particular at an outer region of the rotor blade on the suction side in the vicinity of the rotor blade trailing edge,
implementing a spectral evaluation of the recorded pressure spectrum,
subdividing the pressure spectrum into a first and second partial power density spectrum,
calculating a first and second spectral component by integrating the first and second partial power density spectrum, respectively,
forming a quotient of the first and second spectral component as an indicator value,
comparing the indicator value to a specifiable ratio limit value and assessing a critical flow as being present if the indicator value exceeds the ratio limit value,
reducing the angle of attack of the rotor blade if a critical flow was evaluated as being present and
repeating the aforementioned steps.

Preferably, the blade angle is increased in a restricted range with a predetermined modification angle, in particular of 5° or 10°, in relation to the blade angle that would be set during normal operation. Consequently, this embodiment proposes to implement the aforementioned steps in succession and constantly repeat these in order to continuously record and evaluate the corresponding measurement values and adjust the blade angle when necessary. Reference is made to the fact that an increase in the blade angle here leads to a reduction in the angle of attack.

Moreover, a method for controlling a wind power installation having a rotor with at least one rotor blade that is adjustable in terms of its blade angle is proposed, said method including the following steps:
recording a sound measurement at the wind power installation,
evaluating the sound measurement as to whether infrasound with an amplitude above a prescribable infrasound limit value is present and
modifying at least one operational setting of the wind power installation if the evaluation of the sound measurement has yielded infrasound with an amplitude above a prescribable infrasound limit value being present.

Consequently, initially recording a sound measurement at the wind power installation is proposed here. This may be at the rotor blade, or else at the nacelle or the tower of the wind power installation. A sound measurement in the vicinity of the wind power installation can also be considered. In any case, a sound measurement is proposed here, said sound measuring checking whether infrasound is present at a certain amplitude. This relates, in particular, to an amplitude which, if at all only theoretically, may lead to infrasound that can be perceived by humans or animals. Here, in particular, infrasound is assumed to be sound at a frequency of approximately 1 to 20 Hz; however, it may also be lower than this, e.g., down to 0.1 Hz.

If infrasound at such an amplitude is captured, modifying at least one operational setting of the wind power installation is proposed. To this end, an infrasound limit value can be predetermined and a check can be carried out as to whether the captured infrasound has an amplitude lying over the infrasound limit value.

Here, a combination with at least one of the above-described embodiments considering the capture of a critical incident flow can also be implemented. On account of the phenomena described above, such a critical incident flow can be perceived as a frequency modulation. Similar effects and/or a similar perception setting in for a frequency modulation on the one hand and for infrasound on the other hand may therefore come into question, even though both are physically somewhat different. In the case of the frequency modulation, noises of a certain frequency or of frequency ranges, which lie far above infrasound, occur in pulsating fashion and can therefore possibly be perceived as infrasound or the like because the beat has a frequency in the infrasound range. By contrast, actual infrasound only has a noise at a very low frequency, in particular 20 Hz or less.

Now, a countermeasure proposed in the case of infrasound, if the latter was captured with a correspondingly high amplitude, is that of modifying at least one operational setting of the wind power installation in order thereby to modify the source and/or amplification of infrasound to the best possible extent.

Preferably, modifying the angle of attack of the rotor blade in order to improve the incident flow, which also corresponds to the measure provided according to many of the above-described embodiments, comes into question for adjusting the operational setting.

Moreover, or alternatively, modifying, in particular reducing, the rotor rotational speed is proposed. The source intensity of the infrasound is also reduced as a result.

Moreover, or alternatively, reducing the power produced by the wind power installation comes into consideration. This, too, could be a measure for reducing infrasound. It should be noted here that modifying or reducing the power produced may also have influence on, for example, the size of the resistance the wind power installation puts up against the wind. Accordingly, this measure can also have an influence on the production of sound.

One embodiment proposes that the rotor blade is rotated by a rotor of the wind power installation and
the pressure is recorded over at least one revolution, in particular over a plurality of revolutions, of the rotor, for recording the at least one part of the pressure spectrum and
a plurality of pressure measurements are carried out successively during each revolution, in particular in uniform fashion and/or at uniform intervals, wherein
a current pressure spectrum is determined for each of the pressure measurements and the at least one part of the pressure spectrum is formed by averaging over the current pressure spectra of all pressure measurements of the at least one revolution.

Accordingly, the rotor rotates, in particular during the operation of the wind power installation, and pressure measurements are recorded successively in the process, in particular continuously or quasi-continuously. In particular, measurements are carried out permanently, in particular using a noise sensor that consequently records the pressure. The measurement is evaluated and a power spectrum or a power density spectrum is created, specifically for each measurement or at each measurement time. By way of example, the measurement can be sampled at a sampling frequency that admits the determination of a power spectrum or of a power density spectrum by way of an FFT, for example. This constantly sampled measurement can also be referred to as a quasi-continuous measurement.

A good overall image of the period of time considered in the process arises by averaging, which is formed as an arithmetic mean in the simplest case. It is also possible to average out occasionally occurring strong deviations and these do not play a great role. In particular, such occasionally occurring strong deviations then may influence the proposed regulation of the rotor blade or the rotor blades less. It was also recognized that a value that varies little, which, to this end, does not change, or only changes a little, over several rotations and only leads to a conservative blade adjustment, suffices. Adjusting the rotor blade or the rotor blades too frequently is avoided.

To this end, one embodiment proposes that:
an angle position a of the rotor is captured with the rotation of the rotor, and
each current pressure spectrum is multiplied by the cosine of the angle position α, cos(α), before averaging; in particular, the angle position α to this end is defined in such a way that it assumes a value of 0° when the relevant rotor blade is at the top, i.e., in the 12 o'clock position.

As a result of this measure, uniform noise, i.e., a disturbance signal that is superposed on the characteristic signal that should in fact be evaluated, can be eliminated from, or at least reduced in, the measurement signal. This is based on the idea set out below.

Noises that are able to announce a stall to be avoided occur, in particular, when the rotor blade is at the top, i.e., in the region of a 12 o'clock position of the rotor blade. In this case, these noises form the characteristic signal. This is because wind speeds are regularly higher at the top than at the bottom and therefore a stall is also more likely to occur there. Nevertheless, adjusting the rotor blade not only for the upper region but leaving it adjusted at least for one or more revolutions is proposed. Naturally, a cyclical adjustment of the rotor blades can also be provided if the additional alternating loads on the pitch bearing or motors connected therewith are taken into account.

It was recognized that an approximately uniform noise, namely the disturbance signal, is additionally superimposed on the noises to be identified, i.e., the characteristic signal. However, this disturbance signal occurs substantially independently of the height, i.e., independently of whether the rotor blade is at the top or bottom, whereas the characteristic signal substantially occurs at the top.

Now, if every current measurement signal, or the current pressure spectrum derived therefrom, is multiplied by a cosine of the current or associated angle position of the rotor blade in each case, i.e., if it is multiplied by cos(α), this results in different effects on the disturbance signal on the one hand and the characteristic signal on the other hand. In principle, a cos function, or distribution according to a cosine function, arises for the disturbance signal, which yields zero when averaged over one or more complete revolutions. As a result, the disturbance signal is averaged out and thereby filtered out.

However, the characteristic signal substantially occurs at the top, when the cos function substantially has a value of one. Thus, it is multiplied by one where it occurs with tendentiously high values. Unlike the disturbance signal, it has lower values in the lower region, i.e., in particular, in the region of the 6 o'clock position, said lower values then being included in the averaging with negative signs. Hence, a value not equal to zero arises over one revolution, said value depending on the shear situation.

As a result, it is only or at least predominantly the characteristic signal that remains.

It is particularly advantageous for this effect if the measurement or the averaging is recorded over a whole revolution or a plurality of complete revolutions. However, in the case of many revolutions, e.g., 10 revolutions or more, the described filtering or averaging-out effect will nevertheless set in because the disturbance signal can be significantly reduced in any case as a result thereof.

Moreover, a wind power installation having a rotor with rotor blades that are adjustable in terms of their blade angle is proposed according to the invention, said wind power installation comprising the following:
at least one sensor for recording at least part of a pressure spectrum of a wall pressure at at least one of the rotor blades at at least one measurement position, wherein the wind power installation is prepared
to evaluate at least part of the pressure spectrum,
to assess whether a critical incident flow is present at the rotor blade depending on the evaluation of the pressure measurement and
to adjust the rotor blade in terms of its angle of attack if an incident flow was assessed as critical in order to improve the incident flow.

Preferably, modifying the angle of attack of the rotor blade for improving the incident flow is only carried out when the wind power installation has a rotor rotational speed above a prescribable limit rotational speed. This is based on the discovery that the frequency modulation, in particular, depends not only on the described evaluation of the pressure spectra but may also depend on the rotational speed. In particular, effects at low rotational speeds, which often also coincide with low wind speeds, are lower.

In particular, such a wind power installation is provided to carry out at least one method according to the embodiments described above, or to implement said method therein.

Preferably, at least one sensor being integrated into a rotor blade surface as a potential-free sensor, in particular as an optical sensor, especially as a fiber-optical sensor is provided for the wind power installation. Consequently, such a sensor can be installed at a desired measurement position in the rotor blade in a simple manner. By using a potential-free sensor, such as an appropriately prepared optical fiber cable, for example, it is possible to avoid the risk of lightning striking the rotor blade and, in particular, the sensor.

### BRIEF DESCRIPTION OF THE SEVERAL VIEWS OF THE DRAWINGS

Now, the invention will be explained in more detail below on the basis of exemplary embodiments, with reference being made to the attached figures.

FIG. 1 shows a wind power installation in a perspective illustration.

FIG. 2 is a diagram for explaining separation phenomena at the rotor blade.

FIG. 3 shows two power density spectra for different angles of attack.

FIG. 4 shows curves for indicator values in the case of different boundary conditions.

FIG. 5 shows a diagram for illustrating a control sequence for controlling a wind power installation.

### DETAILED DESCRIPTION

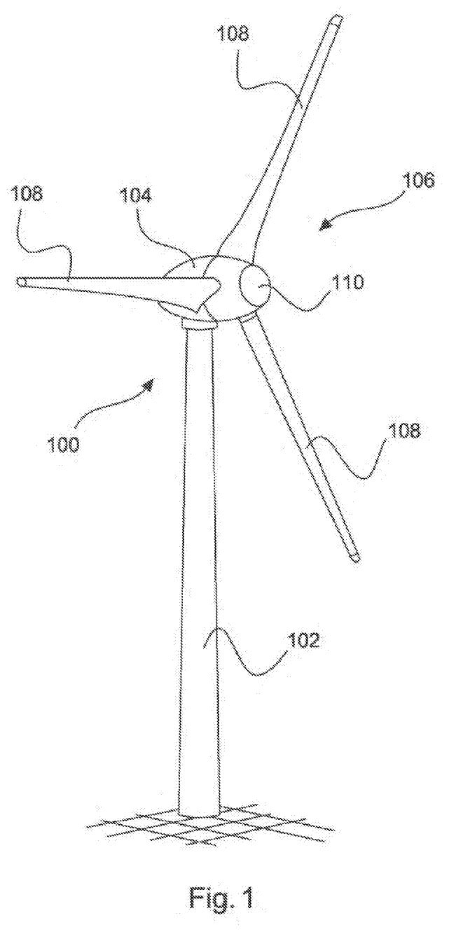

FIG. 1 shows a wind power installation 100 having a tower 102 and a nacelle 104. A rotor 106 with three rotor blades 108 and a spinner 110 is arranged at the nacelle 104. During operation, the rotor 106 is put into a rotational movement by the wind and thereby drives a generator in the nacelle 104.

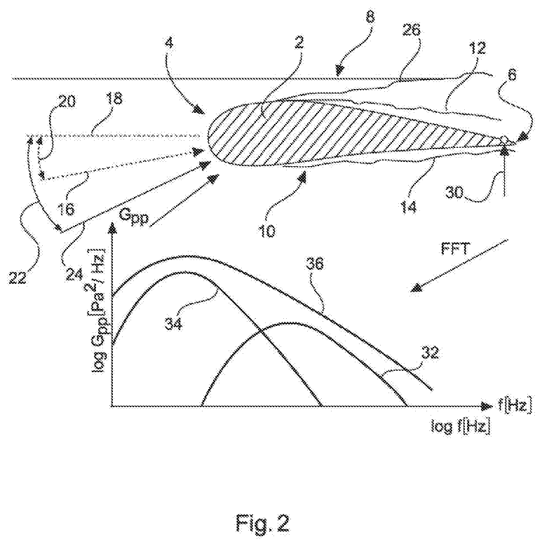

FIG. 2 shows a profile 2 of a rotor blade at a position relevant to the disclosure. The profile, and hence also the rotor blade, has a blade leading edge 4 and a blade trailing edge 6. Moreover, the profile, and, naturally, the rotor blade as well, has a suction side 8 and a pressure side 10. During the operation of the installation in the case of laminar flow conditions, a boundary layer 12 and 14, respectively, forms on both the suction side 8 and the pressure side 10, which can also be referred to as upper and lower side, respectively. These two illustrated boundary layers 12 and 14 belong to an incident flow, which sets in with substantially laminar flow during a desired operation and which is illustrated as a normal incident flow 16. In relation to a comparison direction 18, which, in particular, is parallel to the chord of the rotor blade (not plotted here), a normal angle of attack 20 sets in. Such an angle of attack, i.e., the normal angle of attack 20 and also a critical angle of attack 22, which is explained in more detail below, arise from a vector addition of a vector reproducing the wind speed and a vector corresponding to the movement of the rotor blade with a negative sign.

If there now is an increase in the wind speed in the case of an unchanging movement of the rotor blade, i.e., of the profile 2, there is also a change in the incident flow in terms of its direction up to a critical incident flow 24, plotted in FIG. 2, which has the aforementioned critical angle of attack 22. A critical incident flow should be assumed when there is a change in the upper boundary layer, in particular, i.e., the boundary layer 12 of the suction side 8, and a tendency to separate arises. Such a critical situation is plotted in FIG. 2 with a correspondingly modified boundary layer 26, which is assigned to the critical incident flow 24. The flow noises change and also increase in such a situation.

On the basis of power density spectra, FIG. 2 also explains a noise characteristic underlying the different situations. To this end, a pressure sensor 30 on the suction side 8 and in the vicinity of the blade trailing edge 6 on this relevant profile 2 records pressure signals, specifically sound, in particular. Consequently, the pressure sensor 30 can be a microphone.

These recorded pressure or sound signals can be converted into a power density spectrum by means of an FFT, i.e., a Fourier transform, and the diagram in FIG. 2 shows power density spectra for three situations, specifically a normal power density spectrum 32 that sets in in the case of a normal incident flow, in particular in the case of the normal incident flow 16, a critical power density spectrum 34 that can set in in the case of a critical incident flow, in particular the critical incident flow 24, and a power spectrum in the case of separation 36 that can set in when the flow separates.

These three power density spectra are plotted in a log-log diagram as a power density spectra G_{PP} over frequency f.

In any case, it is possible to identify that there are significant changes in the power density spectra in the various situations. In addition to an increase from the normal to the critical state, it is also possible to recognize a shift in the frequency.

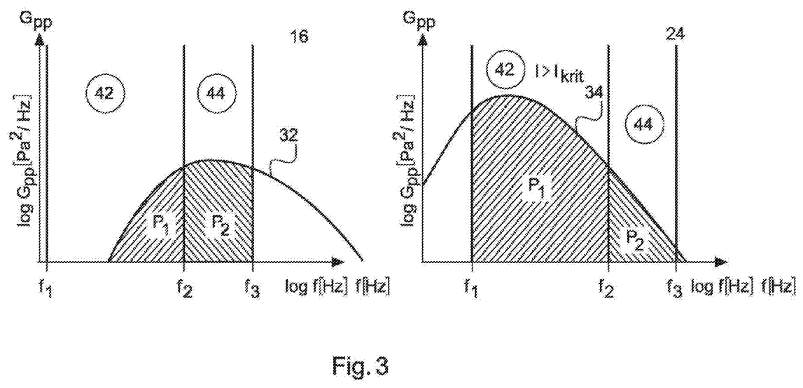

This is now exploited, as explained by FIG. 3. The normal power density spectrum 32 and the critical power density spectrum 34 of FIG. 2 are plotted in separate diagrams in FIG. 3. Here, both power density spectra are subdivided into a low frequency range 42 and a high frequency range 44. The spectral components contained therein in each case are referred to as low spectral component P₁ and high spectral component P₂, respectively.

It is clear that the low spectral component P₁ forms the smaller component during the normal incident flow 16 and forms the greater component during the critical incident flow 24. For evaluation purposes, integrating the partial power density spectra in each case and forming a quotient, which can then be used as an indicator value I, is now proposed. Accordingly, a quotient of the low spectral component P₁ and the high spectral component P₂ according to the following formula is proposed for calculating the indicator value I:

$$I = \frac{{P}_{1}}{{P}_{2}} = {\int }_{{f}_{1}}^{{f}_{2}} {G}_{pp} ( f ) d f / {\int }_{{f}_{2}}^{{f}_{3}} {G}_{pp} ( f ) df .$$

Accordingly, one embodiment proposes dividing the spectrum into the low and high frequency range 42 and 44, respectively. The two power partial density spectra, which emerge from this subdivision, should be integrated in each case and a quotient should be calculated therefrom for the purposes of forming the indicator value. Now, a ratio limit value can be based on a previously calibrated threshold for this indicator value.

If this previously calibrated threshold is exceeded by the indicator value, the rotor blade or rotor blades are rotated slightly out of the wind, for example by initially 1°, which a person skilled in the art and also refers to as pitching out.

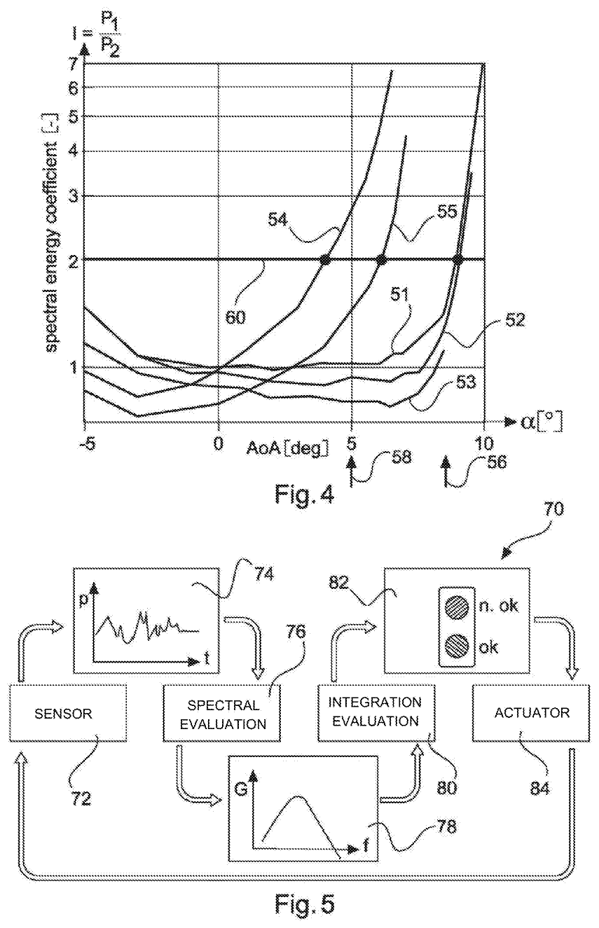

The curves of such indicator values, i.e., of the described quotients I, are plotted in FIG. 4 as a function of the angle of attack for different wind speeds and for clean and dirtied rotor blades. These curves have been gathered from trials in a wind tunnel.

Here, five curves 51-55 are plotted, the following boundary conditions applying thereto:
51: 40 m/s wind speed in the case of a clean blade
52: 60 m/s wind speed in the case of a clean blade
53: 80 m/s wind speed in the case of a clean blade
54: 60 m/s wind speed in the case of a dirtied blade
55: 80 m/s wind speed in the case of a dirtied blade.

For the cases with a clean, i.e., non-dirtied, rotor blade, i.e., for the cases with a very smooth profile surface, the curves of different incident flow speeds, namely 51, 52 and 53, almost coincide. The indicator value, which can also be referred to as the quotient of the power density spectra or as “spectral energy coefficient,” would consequently always detect starting of the separation very well for these clean cases. To this end, only this coefficient would be required and, in particular, knowledge of the incident flow speed and of the rotational speed are not required to this end. For illustration purposes, a clean separation limit 56 is plotted to this end, said separation limit, for instance, denoting an angle of attack, namely approximately 8.5° in this case, in which separation would arise in the case of a clean and hence very smooth profile surface, and said separation limit also arising in trials in a wind tunnel.

For the dirtied case, i.e., the curves 54 and 55, the critical angle of attack is lower than in the clean case. This, too, is mapped by the indicator value, i.e., the indicator values 54 and 55 in this case. However, a slight dependence on rotational speed, namely a dependence on the incident flow wind speed, is visible in this case. For illustration purposes, a dirtied separation limit 58 is also plotted for dirtied rotor blades.

Such an influence of the rotational speed or the wind speed and the dirtying situation can be reduced by choosing suitable limit frequencies. Such limit frequencies, namely the lower, mid and upper frequency f₁, f₂ and f₃, respectively, can be accordingly ascertained in advance and programmed into the corresponding evaluation algorithm. It is also possible for four frequencies to be present, two of which in each case defining a frequency range. Of these, two frequencies could correspond and accordingly form the mid frequency f₂, or, in fact, four different frequencies could be chosen.

Moreover, or alternatively, the described regulation could also be set to be exact only above a sound-critical rotational speed, above which the indicator value operates reliably. Thus, pitching-out on the basis of the indicator value can be proposed only to be carried out once a predetermined minimum rotational speed is present.

Consequently, FIG. 4 shows the relationship of the low spectral component P₁ and the high spectral component P₂ for different boundary conditions. To this end, different limit frequencies were selected, namely the lower, mid and upper frequency or limit frequency f₁, f₂ and f₃, respectively, which also supply a meaningful indicator value in relation to a ratio limit value for different boundary conditions, i.e., in particular, different incident flow wind speeds, even in the case of dirtied rotor blades. In the case of a ratio limit value 60, which has a value of 2 in this case, it is consequently possible to recognize separation tendencies well, even for the different conditions, by way of the indicator value. The frequencies chosen to this end are: f₁=200 Hz, f₂=400 Hz and f₃=600 Hz.

For implementation purposes, attaching the sensor or sensors in the outer region of the rotor blade, on the suction side and in the direct vicinity of the trailing edge, is proposed. From there, fiber-optical lines can be installed in the direction of the hub, where possible along a neutral fiber, for example along a web in the support structure of the rotor blade. There, the sensor or the sensors can be connected to an evaluation unit in the rotor blade, particularly if only one sensor is present, or in the hub, in particular if three sensors are present, namely one sensor per rotor blade. The laser signals cast back by the sensor or sensors, to name but one example, can be evaluated at the evaluation unit.

Then, linking such an evaluation unit, in particular an evaluating microprocessor unit used to this end, to the installation controller and installation regulator of the wind power installation is proposed. As a result, such an evaluated measurement value, i.e., in particular, the indicator value, can cause a displacement of the blade adjustment angle motors toward smaller angles of attack if a threshold calibrated in advance is exceeded. Such a calibrated threshold is plotted in FIG. 4 as a ratio limit value 60. The effect of such a control measure will be a reduction in the indicator value. In relation to the diagram in FIG. 4, this would correspond to a reduction in the angle of attack α, and so the values on the relevant curve change in accordance with this modified angle of attack.

The response of a sensor, i.e., after carrying out the evaluation of the indicator value, can suffice to trigger such an action, namely the adjustment of the rotor blades. Preferably, a subsequent waiting time is provided, which can be one minute, for example, before the blade angle can be rotated back again if the indicator value always lay below the limit value or below the lower hysteresis value during this time. If the indicator value once again exceeds the threshold, the blade angle should be increased further until the indicator value permanently lies below the threshold.

Should the indicator value then not be triggered for a relatively long period of time, for example because modified atmospheric conditions are present, it is possible to reduce the blade angle, which can also be referred to as pitch angle, again for the purposes of increasing the power. This increase for elevating the power can then be realized by the installation controller.

A further embodiment proposes a second, smaller underlying ratio limit value being used as a basis, i.e., a second ratio limit value that is smaller than the ratio limit value 60. As a result, a control hysteresis can be realized in the controller. After the occurrence of an above-described OAM noise, this second ratio limit value would have to be initially (permanently) undershot before the blade angle is reduced again, i.e., before the rotor blade is adjusted again in the direction toward an ideal blade angle.

A control sequence is shown in FIG. 5. Consequently, FIG. 5 shows a control diagram 70, in which a sensor block 72 represents the recording of a time-dependent pressure p, which is shown in the time-dependent pressure diagram 74. This time-dependent pressure curve according to the pressure diagram 74 is then converted into a power density spectrum G_{PP}(f) according to the spectral evaluation block 76 and this result is visualized in the power density spectrum block 78.

Then, the power density spectrum, as illustrated by block 78, is evaluated in the integration evaluation block 80. In this evaluation, a subdivision into two frequency ranges is undertaken on the basis of a lower, mid and upper frequency f₁, f₂ and f₃, respectively. Consequently, the power density spectrum is subdivided into a lower and upper spectral component and these two power density spectra of the low and high spectral component are integrated and a ratio of these two integrated values is formed in order to form an indicator value therefrom.

This indicator value is then compared to a limit value, namely, in particular, a ratio limit value, and a decision is made dependent thereon in the decision block 82 as to whether the indicator value is low enough to still assume a normal incident flow or whether it has exceeded the ratio limit value and it is hence necessary to assume a critical incident flow, shown as not ok (n. ok) in the decision block 82. Otherwise, the result can be visualized as ok in the decision block. Depending thereon, a control signal for increasing the blade adjustment angle for the purposes of reducing the angle of attack is then produced in the actuator block 84 if a critical incident flow being present was determined in the decision block 82, i.e., if the result was not ok. The actuator block 84 can be realized in the central installation controller, the software of which being accordingly expanded in order to take account of the indicator according to the disclosure.

Then, this process shown in the control diagram 70 is continuously repeated. Such repetition can lie in the range of approximately 0.01 to 0.2 seconds. A lower value of 0.01 seconds (i.e., 100 Hz) is particularly advantageous when the indicator is subject to low-pass filtering. Such a high evaluation rate is proposed for this case, in particular.

Consequently, a solution was now proposed here, by means of which an unwanted noise phenomenon, which is also referred to as other amplitude modulation (OAM) in the art, can be prevented or at least reduced. To this end, in particular, sensors integrated into the blade surface, or at least one such sensor, and a control strategy are proposed. By way of a good choice of the parameters, in particular the lower, mid and upper frequency f₁, f₂ and f₃, respectively, it is possible not only to reduce but completely suppress the phenomenon. Moreover, it is particularly advantageous if the evaluation of the measurement signals is independent or at least robust in relation to the calibration, the incident flow speed and the degree of dirtying of the blade or else an erosion of the blade.

Consequently, it was also possible to create a solution that makes do with as little outlay in terms of measurement technology and with as little sensitivity as possible of the method in relation to environmental influences, which influence the object to be measured and could lead to incorrect results. This includes eddies within a turbulent boundary layer, which are responsible for the surface pressure field of the rotor blade.

In particular, the proposed solution is also superior over methods which only detect an OAM event in a far field in order to intervene in the regulation so as to remove the problem again. The solution also has advantages over methods that are based on a determination of the angle of attack since the critical angle of attack depends on the properties of the boundary layer around the rotor blade profile and hence depends on the condition of the surface, in particular on dirtying as well.

1. A method for evaluating an incident flow at a rotor blade of a wind power installation, comprising:
recording at least part of a pressure spectrum of pressure at the rotor blade at at least one measurement position,
determining at least two characteristic values from the pressure spectrum,
determining an indicator value from a relationship between the at least two characteristic values, and
determining, based on the indicator value, whether a critical incident flow is present at the rotor blade.

2. The method as claimed in claim 1, wherein:
the at least two characteristic values include a first spectral value and a second spectral value, and
the first spectral value is a characteristic value of a first frequency range of the pressure spectrum, and
the second spectral value is a characteristic value of a second frequency range of the pressure spectrum that is higher than the first frequency range.

3. The method as claimed in claim 1, wherein:
the pressure spectrum is a power density spectrum and is subdivided into:
a first partial power density spectrum in a first frequency range, and
a second partial power density spectrum in a second frequency range, and
the at least two characteristic values are first and second spectral components, wherein the method comprises:
integrating the first partial power density spectrum over the first frequency range to obtain the first spectral component, and
integrating the second partial power density spectrum over the second frequency range to obtain the second spectral component.

4. The method as claimed in claim 3, wherein:
the first frequency range lies between a first and a second frequency, and
the second frequency range lies between the second and a third frequency, and
the method comprises setting at least one of the first, second and third frequencies according to at least one of:
setting the second frequency such that the power density spectrum has a maximum in the first frequency range when the critical incident flow is present,
setting the first, second and third frequencies such that the frequency range and the second frequency range have the same size,
setting the first, second and third frequencies based on a degree of dirtying of the rotor blade,
setting the first, second and third frequencies based on sound emission limits at an installation site of the wind power installation,
setting the first, second and third frequencies based on sound measurements in a region of the wind power installation, and
setting the first, second and third frequencies in a region of 200 Hz, 400 Hz and 600 Hz, respectively.

5. The method as claimed in claim 2, comprising:
determining, the indicator value as a quotient of two of the at least two characteristic values, as a quotient of the first and second spectral value, or as a quotient of the first and second spectral components, and
determining that the critical incident flow is present if the indicator value is above a specified ratio limit value.

6. The method as claimed in claim 1, wherein the at least one measurement position is:
in a region of a rotor blade trailing edge of the rotor blade,
on a suction side of the rotor blade, or
in a region of the rotor blade the lies longitudinally between 60% to 95% from a connection region of the rotor blade to a blade tip of the rotor blade.

7. A method for controlling a wind power installation having a rotor with at least one rotor blade having an adjustable blade angle, comprising:
determining, at the at least one measurement position, a pressure measurement of the at least one rotor blade,
determining, based on the pressure measurement, whether a critical incident flow is present at the at least one rotor blade, and
adjusting an angle of attack of the at least one rotor blade if the critical incident flow is present.

8. The method as claimed in claim 7, wherein determining whether the critical incident flow is present includes:
recording at least part of a pressure spectrum of pressure at the at least one rotor blade at the at least one measurement position,
determining at least two characteristic values from the pressure spectrum,
determining an indicator value from a relationship between the at least two characteristic values, and
determining, based on the indicator value, critical incident flow is present at the at least one rotor blade.

9. The method as claimed in claim 8, comprising:
adjusting the angle of attack to reduce the indicator value below a limit value.

10. The method as claimed in claim 9, comprising:
determining that the indicator value exceeds an upper hysteresis limit value,
in response to determining that the indicator value exceeds the upper hysteresis limit value, beginning adjusting the angle of attack, and
continuing adjusting the angle of attack until the indicator value drops below a lower hysteresis limit value that is smaller than the upper hysteresis limit value.

11. The method as claimed in claim 7, comprising:
recording at least part of a pressure spectrum of pressure at the at least one rotor blade,
spectrally evaluating the at least part of the pressure spectrum,
subdividing the at least part of the pressure spectrum into a first and second partial power density spectra,
calculating a first and second spectral component by integrating the first and second partial power density spectra, respectively,
obtaining an indicator value as a quotient of the first and second spectral components,
comparing the indicator value to a ratio limit value,
determining that the critical incident flow is present if the indicator value exceeds the ratio limit value,
reducing the angle of attack of the at least one rotor blade if the critical incident flow is determined to be present, and
repeating the steps of recording, spectrally evaluating, subdividing, calculating, obtaining, comparing determining and reducing.

12. The method as claimed in claim 7, comprising:
recording a sound measurement at the wind power installation,
determining whether infrasound having an amplitude above a infrasound limit value is present in the sound measurement, and
modifying at least one operational setting of the wind power installation if the infrasound having the amplitude above the infrasound limit is present in the sound measurement.

13. The method as claimed in claim 12, wherein adjusting the operational setting includes at least one of:
adjusting the angle of attack of the at least one rotor blade to improve incident flow,
modifying a rotor rotational speed of the at least one rotor blade, and
modifying a power produced by the wind power installation.

14. The method as claimed in claim 13, comprising:
adjusting the angle of attack of the at least one rotor blade only when the wind power installation has a rotor rotational speed above a rotational speed limit.

15. The method as claimed in claim 8 comprising:
rotating, by a rotor, the at least one rotor blade,
recording the pressure over at least one revolution of the rotor, for recording the at least part of the pressure spectrum,
performing a plurality of pressure measurements successively during the at least one revolution, and
determining a current pressure spectrum of a plurality of current pressure spectra for each pressure measurement of the plurality of pressure measurements, respectively, by averaging the plurality of current pressure spectra of the plurality of pressure measurements of the at least one revolution.

16. The method as claimed in claim 15, comprising:
determining an angle position of the rotor, and
multiplying each current pressure spectrum is multiplied by a cosine of the angle position before averaging the plurality of current pressure spectra, wherein the angle position is 0° when a rotor blade is at a 12 o'clock position.

17. A wind power installation having a rotor with a plurality of rotor blades that have adjustable angles of attack, comprising:
at least one sensor for recording, at a measurement position, at least part of a pressure spectrum of a wall pressure at at least one rotor blade of the plurality of rotor blades, wherein the wind power installation is configured to:
evaluate the at least part of the pressure spectrum,
determine whether a critical incident flow is present at the at least one rotor blade based on evaluating at least part of the pressure spectrum, and
adjusting an angle of attack of the at least one rotor blade if the critical incident flow is determined to be present.

18. (canceled)

19. The wind power installation as claimed in claim 17, wherein the at least one sensor is integrated into a rotor blade surface of the at least one rotor blade as a potential-free sensor.

20. The method as claimed in claim 1, wherein the pressure is wall pressure.

21. The wind power installation as claimed in claim 19, wherein the at least one sensor is an optical sensor or an fiber-optical sensor.
